(19) United States
(12) Patent Application Publication
(10) Pub. No.: US 2010/0199165 A1
(43) Pub. Date: Aug. 5, 2010

(54) UPDATING WRAPPER ANNOTATIONS

(75) Inventor: Srinivasan H. Sengamedu, Bangalore (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/365,129

(22) Filed: Feb. 3, 2009

(51) Int. Cl. G06F 17/21; G06F 15/18; G06F 11/07

(52) U.S. Cl. 715/230; 706/12; 714/48; 714/E11.024

(57) ABSTRACT

Embodiments of methods, apparatuses, or systems relating to updating wrapper annotations are disclosed.

### CROSS-REFERENCE TO RELATED APPLICATIONS

This application is related to copending U.S. patent application Ser. No. ______, (Attorney Docket Number 070.P079) entitled “Identifying Previously Annotated Web Page Information,” filed on ______.

### BACKGROUND

1. Field

The subject matter disclosed herein relates to wrapper annotations.

2. Information

Web page information, particularly web page content, is continually being generated or otherwise identified, collected, or stored. While various ways exist to collect and/or store web page information, one common approach to do so utilizes a technique called wrapper induction. Generally speaking, wrapper induction may be capable of crawling and collecting web page information from an extensive number of web pages on a daily basis. This collected information may be used for a multiplicity of purposes, such as creating a more centralized database for web page information that would otherwise typically exist on a disparate plurality of web pages, as just one example.

With so much web page information being available, there is a continuing need for methods or systems that may allow for web page information to be collected and/or stored in an efficient manner.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting an embodiment of a method to update wrapper annotations.

FIG. 2 is a schematic diagram illustrating two versions of the same web page in accordance with an embodiment.

FIG. 3 is a schematic diagram depicting an embodiment of a system to update wrapper annotations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment”, “an embodiment”, or “certain embodiments” may mean that a particular feature, structure, or characteristic described in connection with one or more particular embodiments may be included in at least one embodiment of claimed subject matter. Thus, appearances of the phrase “in one embodiment”, “an embodiment”, “certain embodiments”, or the like in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and”, “and/or”, and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals, information, and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's memories, registers, and/or other information storage, transmission, and/or display devices.

As mentioned previously, there are numerous ways in which to extract information from web pages. One approach, for example, may utilize a technique called wrapper induction. Many variations of wrapper induction exist; in one example, wrapper induction may utilize or otherwise take advantage of annotations or tags in a markup language that delineate at least a portion of the web page information that may be extracted. For example, a human editor may create a wrapper that delineates certain information within an HTML, XML, and/or other like web page document/file to be extracted. By way of example but not limitation, a human editor may delineate a title, heading, and/or other like annotation or tag for a web page. The resulting wrapper may then be utilized to extract the corresponding information from the web page (and/or other like web pages).

To illustrate, for example, a particular web page may contain a title of a particular item for sale, such as a type of camera, and a sales price for that item. Human editors viewing this page may delineate (e.g., “annotate”) the title and sales price for the item on this particular web page for extraction by wrapper induction.

Typically, human editors annotate a relatively small number (e.g., few tens) of the web pages associated with a website, especially websites with a relatively large number of web pages that may exist and/or otherwise be generated. Such websites, for example, may employ a similar structure or format across the various web pages to provide continuity and ease of viewing for users interacting with the website. Thus, web pages on a retailer's website listing televisions for sale may provide title and price information in a similar location on a displayed web page as might another displayed web page that lists the title and price information for cameras. As such, wrapper induction may allow human editors to create one or more wrappers based on a small number of the pages on a particular website, which may then be utilized to extract information on a set of web pages associated with the website.

One technique that may improve wrapper induction in certain implementations is known as clustering. Here, web pages that may have a similar structure may be identified and clustered, or grouped, so that a template wrapper, or a more generic wrapper “trained” on a set or subset of web pages in a cluster, may be utilized to extract information from web pages throughout that cluster. Wrapper induction augmented with such a clustering technique may be used to extract web page information across a multiplicity of web pages. Such a clustering technique may be achieved via an automated process.

As illustrated in the examples presented above, wrapper induction often relies on human editors to identify or annotate information of a particular web page, which may introduce significant cost. Moreover, the use of human editors may introduce additional delays and may not be particularly effective where the information of a particular web page changes; even, in some instances, where the changes may be characterized as relatively minor. For example, websites may change the structure of a web page, such as by altering the location of the title of an item, or its sale price, on the web page. In this instance, for example, wrapper induction may not extract the desired information correctly. Thus, a human editor may need to re-annotate a particular web page if a wrapper does not extract the desired information.

A Conditional Random Field (“CRF”) process may be another approach to extract information from web pages. A CRF process identifies information on a web page to be extracted differently than the previously described wrapper induction approach. By way of example, a CRF process may include a stochastic sequential process that may be capable of identifying features in a web page which may indicate desired information to be extracted. Features, for example, may include such information as a currency symbol, a telephone number, or bolded text or larger font, as non-limiting examples. Thus, a CRF process may be capable of identifying features on a particular web page which may be useful to identify information to extract.

To illustrate, for example, a retailer's website may list a price of an item for sale on a particular web page. A CRF process may be trained so that it may determine that price is typically a number juxtaposed with a currency symbol. Thus, a CRF process, based at least in part on its training, may determine that a number and currency symbol are juxtaposed somewhere on a web page in a manner suggesting that the number may be a price. Accordingly, a CRF process may extract this price information.

As may be evident from the above CRF description, a CRF process may represent a more robust approach to extract information where the structure of a web page, or set of web pages, undergoes a change. For example, in wrapper induction, a change in the structure or formatting of a web page may occasion an error in wrapper induction such that annotated information may not be extracted correctly, or at all; a CRF process, in contrast, may identify information somewhat independently of web page structure or formatting and extract information correctly even after a web page has undergone a structural or formatting change.

While a CRF process has shown promise in its ability to extract information after structural or formatting variations, there may be disadvantages to the CRF process approach. For example, a CRF process may be generally less precise in extracting information than an annotated wrapper. One reason this may occur, for example, may be that a CRF process may be trained to extract from multiple sites. Also, training of a CRF process and extraction via a CRF process may sometimes be slower than wrapper training or wrapper extraction. Thus, other technologies or approaches may be desired in place of the previously described approach.

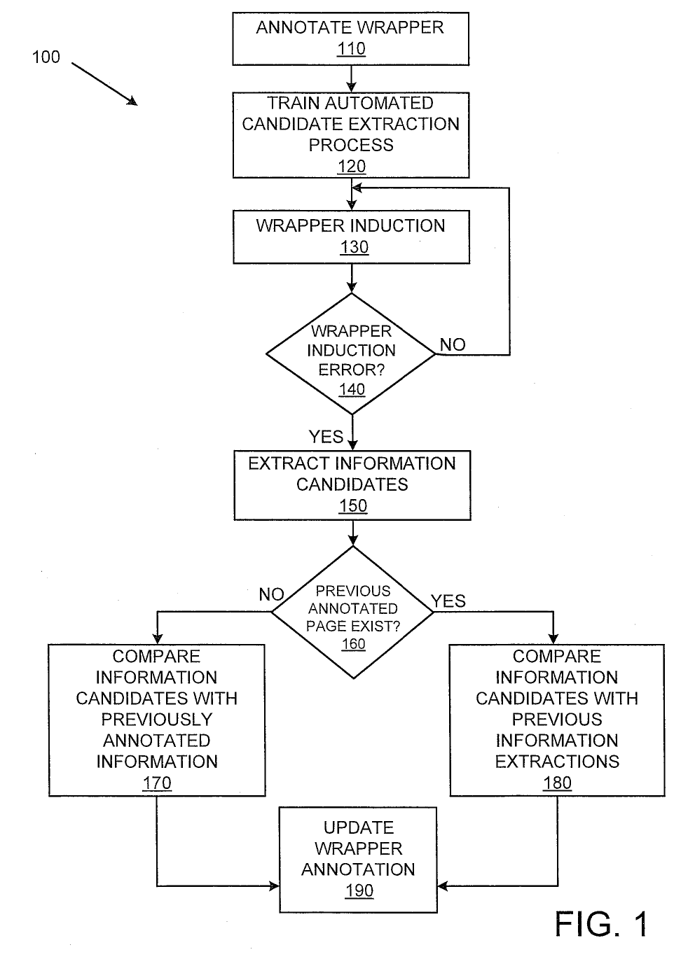

With this and other concerns in mind, in accordance with certain aspects of the present description, example implementations may include methods, systems, or apparatuses for updating wrapper annotations. FIG. 1, for example, is a flow chart depicting an embodiment 100 of a method to update wrapper annotations. Embodiment 100 at block 110 comprises annotating a wrapper for a set of web pages. Here, for example, human editors may annotate some percentage of web pages in a set of web pages for wrapper induction. In this example embodiment, the phrase “set of web pages” refers to a plurality of web pages clustered for wrapper induction. As one example, a cluster may comprise some or all web pages on a particular website, grouped together for wrapper induction purposes. Thus, a particular website may be clustered into one or more clusters, typically with each cluster having a particular wrapper. In other embodiments, however, a “set of web pages” may refer to a single web page, a plurality of web pages from a single or multiple websites, or a plurality of web pages from multiple clusters from a single or multiple websites, as non-limiting examples.

Embodiment 100 at block 120 shows an automated candidate extraction process, such as a site-specific CRF process, training on a set of web pages. In this context, the term “automated candidate extraction process” refers to one or more processes that may be trained to extract “information candidates” from one or more web pages. To illustrate, in a certain implementation, a site-specific CRF process, for example, may be trained at least in part on information from a particular website, or on information from a particular set of web pages on a website, such that it may identify information candidates to extract. The phrase “information candidate” and/or the term “candidate” are discussed in more detail below; first, however, a brief discussion of one particular automated candidate extraction process—a site-specific CRF process—may be warranted.

A site-specific CRF process may differ in various respects from a non-site-specific CRF process, which was mentioned previously. For example, one respect in which a site-specific CRF process may differ from a non-site-specific CRF process may be that a site-specific CRF process may be trained to more specifically identify web page information for web pages on a particular website. Accordingly, in this regard, a site-specific CRF process may tend to have improved precision and recall for web pages on a particular website as opposed to a CRF process that may not have been trained on that particular website. Of course, in other embodiments, other automated candidate extraction processes may be trained to identify information to be extracted. For example, other automated candidate extraction processes, such as Hidden Markov Models (HMM) or Support Vector Machine (SVM) or other machine-learning models or techniques, may be trained, as non-limiting examples. As another example, a non-site specific CRF process, such as previously described, may be trained at block 120.

In addition, at block 120, an automated candidate extraction process, such as a site-specific CRF process, may be trained based, at least in part, on wrapper annotations for a set of web pages. For example, training information used to train an automated candidate extraction process, such as a site-specific CRF process, may include wrapper annotations for a set of web pages on a particular website, such as one or more wrapper annotations generated at block 110. For example, one way to train an automated candidate extraction process may be train the process on feature/annotation pairs.

To illustrate, a portion of HTML code, such as the portion “<div> Price: $300 </div>” may be labeled or annotated by a human editor as “price” at block 110. Typically, as illustrated in the above portion of HTML code, a price often includes a currency symbol, such as “$”, and/or a number, such as “300”. Accordingly, the annotation “price” may be paired with particular features, such as contains “$” or contains a “number”, as a non-limiting example. In addition, in embodiment 100, an automated candidate extraction process, such as a site-specific CRF process, may be trained on wrapper annotations for a plurality of wrappers. Thus, an automated candidate extraction process may be trained to extract information relating to a plurality of wrappers for a particular website, for example.

Embodiment 100 at block 130 shows an annotated wrapper performing wrapper induction to extract information from a set of web pages. For example, web pages in a set of web pages may be processed (e.g., crawled, etc.) to extract information based at least in part on the annotated wrapper. Here, for example, extracted web page information may be stored in one or more databases or the like, such as may be provided in one or more servers.

At block 140, it may be determined (e.g., using an automated process) if there may be errors in the extracted webpage information as a result of wrapper induction. Here, for example, the extracted web page information may be examined determine if a wrapper extracted information correctly (e.g., based on extraction records, etc.), or did not extract information at all. As mentioned previously, a wrapper may not correctly extract information if, for example, a particular web page, or a set of web pages, undergoes a change, particularly a structural or format change. Alternatively or additionally, at block 140 in certain embodiments, an automated process may be employed to detect potential changes in a set of web pages, such as format or structural changes, prior to wrapper induction (not depicted).

Continuing with an illustrative embodiment, if a wrapper induction error is detected at block 140 (“YES”), block 150 shows an automated candidate extraction process, such as a site-specific CRF process, which may be utilized to extract web page information that may have extracted incorrectly, or not at all, via wrapper induction. For example, in an embodiment, block 150 depicts an automated candidate extraction process, such as an automated candidate extraction process trained at block 120, processing (e.g., crawling) a set of web pages where a wrapper induction error may have occurred to extract information. The information extracted at block 150 is referred to as “information candidates” and/or “candidates”. If, however, no wrapper induction error is detected at block 140, (“NO”) then wrapper induction may continue to extract web page information at block 130.

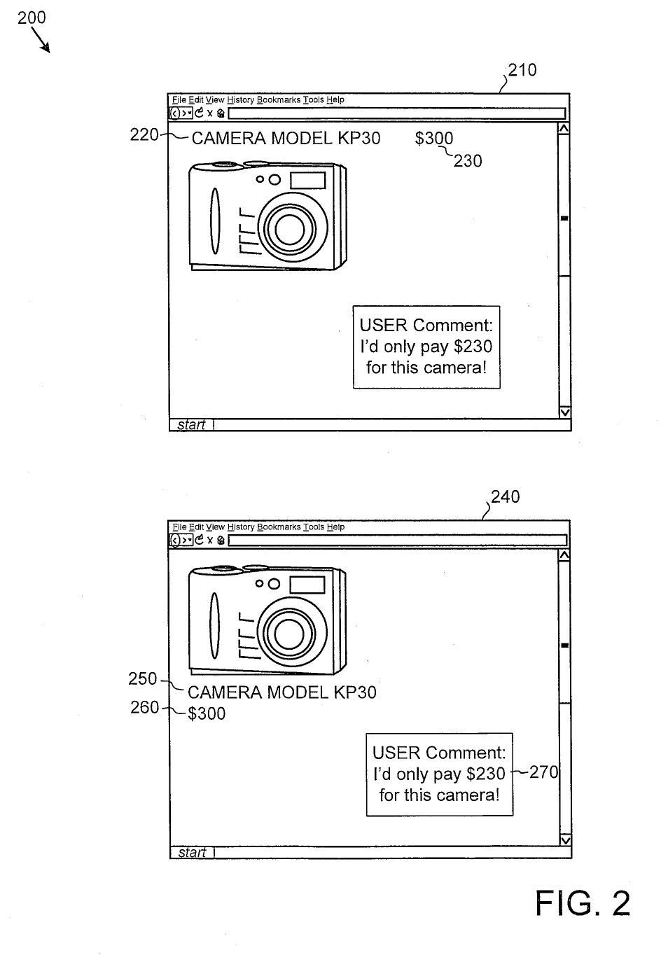

FIG. 2 may serve as a helpful reference to illustrate some of the concepts mentioned previously. For example, embodiment 200 in FIG. 2 depicts two versions of the same displayed web page. Here, displayed web page 210 lists a particular type of camera for sale. Title 220 and price 230 of the particular camera are listed on displayed web page 210. Displayed web page 240, in contrast, depicts a subsequent version of displayed web page 210 having a different structure. For example, title 250 and price 260 in displayed web page 240 are located in a different position compared to title 220 and price 230 on displayed web page 210.

Continuing with the illustration, assume title 220 and price 230 in web page 210 were previously extracted via wrapper induction, such as may be performed at block 130 in FIG. 1. Thus, in this illustration, title 220 and price 230 in displayed web page 210 were previously annotated for wrapper induction. In this illustration, assume, however that a wrapper induction process did not extract title 250 and price 260 on newer displayed web page 240. That is, the wrapper did not extract information previously annotated on displayed web page 210 from newer displayed web page 240. One reason a wrapper may not extract information correctly, or at all, may be that the content delineated by an annotation or tag (e.g., title 220 and price 230 in web page document/file associated with displayed web page 210) may no longer be associated with the same content (e.g., title 250 and price 260 in web page document/file associated with displayed web page 240) after a change, as just one example. Thus, for example, an automated candidate extraction process, such as a site-specific CRF process, may be used to process (e.g., crawl) web page 240 and extract title 250 and price 260, such as may be performed by block 150 in FIG. 1.

Occasionally, an automated candidate extraction process, such as a site-specific CRF process, may identify and extract multiple “information candidates” from a particular web page. In this context, the phrase “information candidates” or the term “candidate” refers to any information that may be identified or extracted by an automated candidate extraction process which, based at least in part on its training, if any, may correspond to previously annotated information and/or previous information extractions. To illustrate, reference is again made to FIG. 2 which shows displayed web page 240 with price 260 and price 270. While in the above example price 260 was recognized and extracted via an automated candidate extraction process, other instances or variations of a price on displayed web page 240, such as price 270, may also be recognized by an automated candidate extraction process and extracted.

Returning to FIG. 1, information candidates extracted at block 150, such as price 260 and price 270 on displayed web page 240, may be compared with previously annotated information, or previous information extractions, to determine which candidate may correspond to previously annotated information or previous information extractions. For example, information candidates, such as price 260 and/or price 270, may be compared to previously annotated information, such as price 230, to determine which candidate corresponds to price 230. There are a variety of techniques to perform this comparison step. Use of some of these techniques may depend, at least in part, on whether the previous annotated web page exists.

Embodiment 100 at block 160 determines if a particular previous annotated web page exists. In this embodiment, the determination at block 160 of whether a particular previous annotated web page exists determines whether candidates may be compared with previously annotated information or whether candidates may be compared with previous information extractions. While in certain embodiments, previously annotated information and/or previous information extractions may refer to similar and/or identical web page information, a distinction between the two may be made where it is determined that a particular web page may not exist. For example, if, at block 160, a process determines that a particular prior version of an annotated web page exists, then previous annotations for that web page—that is, annotations delineating information on that particular web page—may also exist. Accordingly, here, candidates associated with a particular subsequent version of a web page may be compared with previously annotated information from a prior version of that particular web page. In contrast, in an environment where a particular previous annotated web page may not exist, a comparison process may utilize previous information extractions to compare with extracted candidate information. Here, for example, candidates may be compared with previous information extractions (e.g., information extracted previously via wrapper induction and/or extraction records) for any web page in a set of web pages.

If the previous annotated web page exists, block 170 depicts a process in which candidates may be compared with previously annotated information. While claimed subject matter is not to be limited to a particular comparison technique, one technique that may be utilized in block 170, for example, is described in related, copending U.S. patent application Ser. No. ______, (Attorney Docket Number 070.P079) entitled “Identifying Previously Annotated Web Page Information,” filed on ______. A simplified recitation of this technique is described below.

In this particular technique, comparison may comprise a database in which wrapper extracted information and extracted candidates may be stored executing instructions to compare extracted candidates with previously annotated information using one or more comparison approaches. For example, one or more comparison approaches may include at least one of the following: content comparison, structural comparison, context comparison, or a combination thereof.

In an implementation, for example, content comparison may comprise comparing candidates with previously annotated information using string comparison. To illustrate, referring again to FIG. 2, title 220 in displayed web page 210 may represent previously annotated information, such as information previously annotated for wrapper induction. Likewise, title 250 in displayed web page 240 may represent a candidate of web page information, such as information extracted via an automated candidate extraction process, such as a site-specific CRF process. Content comparison may comprise comparing textual or numeric content of title 220 with textual or numeric content of title 250 to identify substantially similar or matching content. While there are many ways to perform textual or numeric comparison, one way may comprise employing a fuzzy string matching technique, such as Levenshtein Distance, for example. Of course, content comparison using a fuzzy matching technique is only one example of an approach to compare content; accordingly, in another implementation, other content comparison schemes may be employed. In an implementation, content comparison, using one or more content comparison techniques, may score candidates to determine their similarity/dissimilarity with previously annotated information. In an implementation, candidates that may better correspond to previously annotated information may score higher than candidates that may not correspond as well.

Additionally or alternatively, in an implementation, structural comparison may be employed. Structural comparison, for example, may comprise comparing structural information from previously annotated information with structural information from candidate information. For example, a query language, such as XML Path Language, for example, may be utilized to identify Xpaths for previously annotated information and/or Xpaths for extracted candidate information, which may then be compared. To illustrate, comparison of Xpaths may comprise determining a distance between Xpaths of one or more extracted candidates with an Xpath of previously annotated information. One rationale animating this approach, for example, may be that web pages changes are more often minor in character. Accordingly, in an implementation, candidates with a shorter distance may better correspond to previously annotated information as opposed to candidates with respectively longer distances. Of course, structural comparison using Xpaths is only one example of an approach to compare structure; accordingly, in another embodiment, other structural comparison schemes may be employed. In an embodiment, structural comparison, such as comparing Xpaths, may score candidates to determine their similarity/dissimilarity with previously annotated information.

Additionally or alternatively, in an implementation, context comparison may be employed. Context comparison may include comparing contextual or associated information from previously annotated information with contextual or associated information from candidates. While types of contextual or associated information may vary considerably from web page to web page, this type of information may include, for example, color information, symbol information, punctuation information, bolding information, italic information, underlining information, and/or the like. To illustrate, in an implementation, previously annotated information may be of a certain color, font size and may be underlined, as just an example. Thus, context comparison may comprise comparing contextual or associated information relating to previously annotated information with contextual or associated information relating to one or more candidates. In an implementation, context comparison, such as comparing contextual or associated information, may score candidates to determine their similarity/dissimilarity with previously annotated information. Candidates with similar contextual or associated information may score higher than candidates with at least some dissimilar contextual or associated information.

In an implementation, one or more correspondence scores determined by using one or more of the above approaches may be utilized to determine which candidate may correspond to previously annotated information. For example, a particular candidate with a respectively better (e.g., higher) composite or individual correspondence score may be identified as corresponding to previously annotated information.

Block 180 in FIG. 1 depicts a comparison process which may be utilized if a particular previous annotated web page may not exist. For example, block 160 may determine that a particular previously annotated web page does not exist. In an implementation, for example, one or more processes may compare previous information extractions (e.g., previously extracted information and/or extraction records) for any web page in a set of web pages with one or more candidates.

Various approaches may be utilized to compare previous information extractions with candidate information. While claimed subject matter is not to be limited to a particular approach, comparison may comprise using one or more of the comparison approaches mentioned previously. For example, one or more databases in which previous information extractions or candidate information may be stored, may execute instructions to perform content comparison, such as a fuzzy string matching technique. As above, in an implementation, one or more approaches may produce an individual or composite correspondence score. Correspondence scores may be utilized to determine which candidate may better correspond to previous information extractions. For example, a particular candidate with a respectively better (e.g., higher) composite or individual correspondence score may be identified as corresponding to previous information extractions.

In certain embodiments, if one or more comparison processes at blocks 170 or 180 do not identify a particular corresponding candidate, then an automated candidate extraction process at block 150 may be retrained and/or may reprocess (e.g., re-crawl) a particular set of web pages to extract one or more candidates.

Block 190 depicts updating a wrapper annotation. For example, in an implementation, block 170 or block 180 may identify a particular candidate which corresponds to previously annotated information or previous information extractions, such as previously described. If so, block 190 depicts updating a wrapper annotation so that a wrapper may be operable to identify and/or extract corresponding candidate information from a newer web page. Depending on the embodiment, a variety of techniques exist to update a wrapper annotation. For example, in an implementation, a previous annotation for a previous version of a web page may be transferred to update a wrapper for corresponding information on a subsequent version of that particular web page. For example, if an annotation delineating title 220 in web page 210 exists, that particular annotation may be transferred to corresponding title 260 in web page 240.

In another implementation, for example, a wrapper may be updated by generating an annotation. For example, as mentioned previously, in an implementation, a site-specific CRF process may be trained on feature/annotation pairs. Accordingly, a site-specific CRF process may generate a particular annotation that may be paired with that particular corresponding candidate information. Thus, in an implementation, an updated wrapper may then be operable to successfully extract corresponding information from a subsequent web page based, at least in part, on updated wrapper annotations.

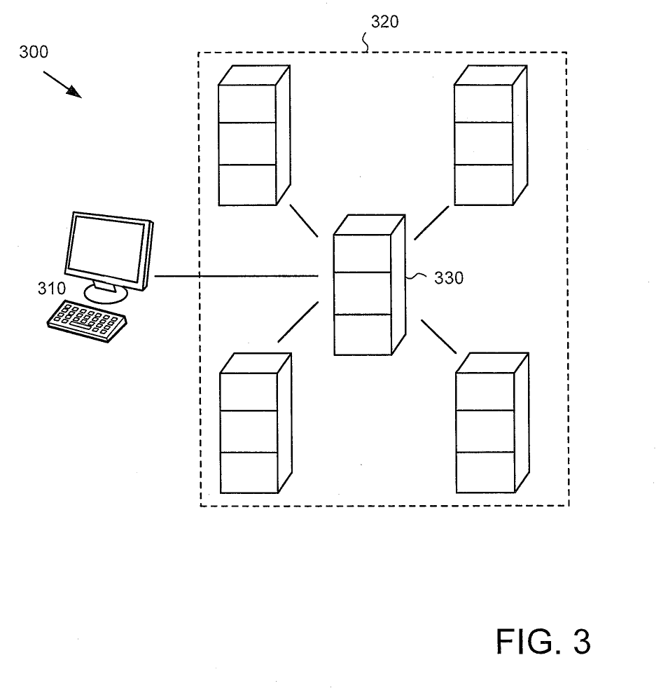

FIG. 3 is a schematic diagram depicting an embodiment of a system to update wrapper annotations. Embodiment 300 depicts a computing platform 310 communicatively coupled to a network of computing platforms 320. Similarly, computing platform 330 is depicted as being communicatively coupled to network 320. In this embodiment, network 320 may be a network of servers, such as an intranet of servers, for example. In addition, in this embodiment, network 320 may be communicatively coupled the World Wide Web and/or the Internet (not depicted), and/or other like networks.

In certain embodiments for example, computing platform 330 may include a special purpose computing platform. In this context, the phrase “special purpose computing platform” means or refers to a computing platform once it is programmed to perform particular functions pursuant to instructions from program software. For example, in an embodiment, computing platform 330 may be capable of performing one or more various processes previously described, such as a wrapper induction process, a candidate extraction process, or a comparison process, as non-limiting examples. Accordingly, in an embodiment, computing platform 330 may have stored thereon various instructions capable of performing one or more of the processes mentioned previously.

In addition, in an embodiment, computing platform 330 may communicate via a communication protocol, with one or more other computing platforms, such as networked computing platforms in network 320, to perform part, or all, of one or more processes, such as or more process mentioned previously. In addition, in an embodiment, network 320 or computing platform 330 may be communicatively coupled to other computing platforms via the Internet (not depicted), and/or other like networks. Thus, for example, computing platform 330, or one or more computing platforms in network 320, may be capable of processing (e.g., crawling, etc.) web page information via the Internet, such as by communicating with one or more computing platforms via the Internet utilizing a HTTP compliant or HTTP compatible communication protocol. Accordingly, in an embodiment, computing platform 330, or one or more computing platforms in network 320, may extract or store web page information, such as previous described.

Of course, in another embodiment, computing platforms other than, or in addition, those depicted in embodiment 300 may be capable of performing one or more of the various operations mentioned previously. For example, one or more of the computing platform communicatively coupled to network 320 (not depicted) may perform some part, or all, of one or more of the operations previously described.

Various embodiments may have a variety of advantages. In an embodiment, for example, one advantage may be that there may be no need for human editors to re-annotate wrappers. Put differently, wrappers re-annotation may be an automatic process in an embodiment. For example, as mentioned previously, re-annotation by human editors may not be desirable because it may be expensive, time-consuming, and may generate additional cost as opposed to a more automated approach. One advantage of an embedment, then, may be that updating wrapper annotations automatically may permit a wrapper to extract web page information without a human editor re-annotating the wrapper. This may lower costs and increase efficiency relating to the wrapper induction approach.

Another advantage of an embodiment, for example, may be that wrappers may more efficiently extract web page information. Accordingly, in an embodiment, more information, and potentially more current information, may be extracted. For example, human re-annotation may take more time as opposed to a more automated approach. One reason this may occur may be that human re-annotation typically occurs in response to a wrapper induction error. In contrast, in an embodiment, an automated process may an automatically update wrapper annotations in response to a wrapper induction error. Thus, wrapper extracted information may extract more information, which may be more current, and may do so with less down time than a wrapper that relies on human re-annotation.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
using an automated candidate extraction process to obtain one or more annotations for one or more web pages of a set of web pages; further comprising updating a wrapper associated with said one or more web pages of said set of web pages based, at least in part, on said one or more annotations.

2. The method of claim 1, further comprising, prior to said using an automated candidate extraction process, training said automated candidate extraction process on said one or more web pages of said set of web pages.

3. The method of claim 2, further comprising training said automated candidate extraction process on one or more annotations associated with said one or more web pages of said set of web pages.

4. The method of claim 1, further comprising, prior to said using an automated candidate extraction process, extracting web page information from said one or more web pages of said set of web pages via a wrapper induction process.

5. The method of claim 4, further comprising detecting a wrapper induction error.

6. The method of claim 1, wherein said using an automated candidate extraction process to obtain one or more annotations for one or more web pages of a set of web pages comprises extracting one or more information candidates from said one or more web pages of said set of web pages via said automated candidate extraction process.

7. The method of claim 1, wherein said using an automated candidate extraction process to obtain one or more annotations for one or more web pages of a set of web pages comprises comparing one or more information candidates, at least in part, with previous information extractions, at least in part.

8. The method of claim 7, wherein said previous information extractions comprises information previously extracted via a wrapper induction process.

9. The method of claim 7, wherein said comparing said one or more information candidates, at least in part, with previous information extractions, at least in part, further comprises calculating a correspondence score.

10. The method of claim 1, wherein said updating a wrapper associated with said one or more web pages of said set of web pages based, at least in part, on said one or more annotations comprises transferring said one or more annotations obtained using said automated candidate extraction process to update one or more annotations of said wrapper.

11. The method of claim 1, wherein said updating a wrapper associated with said one or more web pages of said set of web pages based, at least in part, on said one or more annotations comprises said automated candidate extraction process generating said one or more annotations to update said wrapper.

12. The method of claim 1, wherein said automated candidate extraction process comprises a site-specific CRF process.

13. An apparatus comprising:
a special purpose computing platform; said special purpose computing platform further comprising a storage medium having instructions stored thereon; said storage medium, if said instructions are executed, further instructing said computing platform to update a wrapper annotation for one or more web pages of a set of web pages using one or more annotations obtained from said one or more web pages of said set of web pages via an automated candidate extraction process.

14. The apparatus of claim 13, wherein said automated candidate extraction process comprises a site-specific CRF process.

15. The apparatus of claim 13, wherein said special purpose computing platform comprises a server; wherein said server is communicatively coupled to a network of servers.

16. The apparatus of claim 15, wherein said network of servers comprises at least part of an intranet.

17. A system, comprising:
a computing platform; said computing platform being operable to perform automated candidate extraction to obtain one or more annotations for one or more web pages of a set of web pages; said computing platform further being operable to update a wrapper associated with said one or more web pages of said set of web pages based, at least in part, on said one or more annotations.

18. The system of claim 17, wherein said computing platform is communicatively coupled to a network of computing platforms.

19. The system of claim 18, wherein said network of computing platforms comprises at least part of the Internet.

20. The system of claim 17, wherein computing platform is further operable to perform wrapper induction.
